(19) United States
(12) Patent Application Publication
(10) Pub. No.: US 2007/0271401 A1
(43) Pub. Date: Nov. 22, 2007

(54) TECHNIQUES TO MODERATE INTERRUPT TRANSFER

(76) Inventors: Eliel Louzoun, Jerusalem (IL); Mickey Gutman, Zichron-Yaacov (IL)

Correspondence Address: CAVEN & AGHEVLI;c/o INTELLEVATE, P.O. BOX 52050, MINNEAPOLIS, MN, 55402, US

(21) Appl. No.: 11/383,613

(22) Filed: May 16, 2006

(51) Int. Cl. G06F 13/26

(52) U.S. Cl. 710/264

(57) ABSTRACT

Techniques are described herein that can be used to moderate the rate at which interrupts are emitted. A network component includes the capability to issue interrupts in response to receipt of network protocol units designated as regular and high priority or in response to other causes. High priority interrupts may be accumulated. A number of accumulated high priority interrupts may be decremented each time either a regular or high priority interrupt is transferred. Addition to a number of accumulated high priority interrupts may occur at a higher rate than a rate of availability of regular priority interrupts. A counter may be used to make regular priority interrupts available. The counter may be reset each time a high priority interrupt is provided.

### FIELD

The subject matter disclosed herein relates to techniques to moderate interrupt transfer.

### RELATED ART

When a packet is received at a receiver, the receiver may issue an interrupt to a processor (e.g., a central processing unit (CPU)) to process the packet. In the absence of any interrupt moderation scheme, the receiver will interrupt the CPU every time a packet is received. In order to handle the interrupt, the CPU suspends its current activity. Typically, suspending current activity involves saving state information and executing an interrupt handler. A device driver examines the receiver to determine the cause of the interrupt. The device driver may also take additional actions based on the exact nature of the interrupt. The CPU then resumes its previous activity.

At low traffic rates, this behavior is acceptable because this process occurs relatively infrequently. However, as traffic rates increase, the system spends more and more time servicing interrupts. The overhead of processing these interrupts begins to degrade overall system performance as the CPU spends the majority of its time scheduling and executing the interrupt handler. If the traffic rate continues to increase, the traffic may overrun a network interface causing it to drop packets, or the system itself may become temporarily unusable.

### BRIEF DESCRIPTION OF THE DRAWINGS

Embodiments of the present invention are illustrated by way of example, and not by way of limitation, in the drawings and in which like reference numerals refer to similar elements.

FIG. 1 depicts an example system embodiment in accordance with some embodiments of the present invention.

FIGS. 2 and 3 depict examples of elements that can be used to moderate interrupt generation in accordance with some embodiments of the present invention.

FIG. 4 depicts an example flow diagram that can be used to moderate interrupts provided to a host system in accordance with some embodiments of the present invention.

### DETAILED DESCRIPTION

Reference throughout this specification to “one embodiment” or “an embodiment” means that a particular feature, structure, or characteristic described in connection with the embodiment is included in at least one embodiment of the present invention. Thus, the appearances of the phrase “in one embodiment” or “an embodiment” in various places throughout this specification are not necessarily all referring to the same embodiment. Furthermore, the particular features, structures, or characteristics may be combined in one or more embodiments.

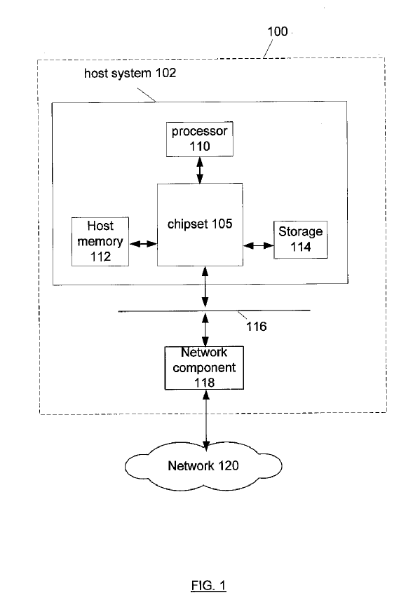

FIG. 1 depicts in computer system 100 a suitable system in which some embodiments of the present invention may be used. Computer system 100 may include host system 102, bus 116, and network component 118.

Host system 102 may include chipset 105, one or more of processor 110, host memory 112, and storage 114. Chipset 105 may provide intercommunication among processor 110, host memory 112, storage 114, bus 116, as well as a graphics adapter that can be used for transmission of graphics and information for display on a display device (both not depicted). For example, chipset 105 may include a storage adapter (not depicted) capable of providing intercommunication with storage 114. For example, the storage adapter may be capable of communicating with storage 114 in conformance at least with any of the following protocols: Small Computer Systems Interface (SCSI), Fibre Channel (FC), and/or Serial Advanced Technology Attachment (S-ATA).

In some embodiments, chipset 105 may include data mover logic (not depicted) capable to perform transfers of information within host system 102 or between host system 102 and network component 118. As used herein, a “data mover” refers to a module for moving data from a source to a destination without using the core processing module of a host processor, such as processor 110, or otherwise does not use cycles of a processor to perform data copy or move operations. By using the data mover for transfer of data, the processor may be freed from the overhead of performing data movements, which may result in the host processor running at much slower memory speeds compared to the core processing module speeds or can allow the processor to do more processing tasks. A data mover may include, for example, a direct memory access (DMA) engine. In some embodiments, data mover may be implemented as part of processor 110, although other components of computer system 100 may include the data mover.

Processor 110 may be implemented as Complex Instruction Set Computer (CISC) or Reduced Instruction Set Computer (RISC) processors, multi-core, or any other microprocessor or central processing unit. Host memory 112 may be implemented as a volatile memory device such as but not limited to a Random Access Memory (RAM), Dynamic Random Access Memory (DRAM), or Static RAM (SRAM). Storage 114 may be implemented as a non-volatile storage device such as but not limited to a magnetic disk drive, optical disk drive, tape drive, an internal storage device, an attached storage device, flash memory, battery backed-up synchronous DRAM (SDRAM), and/or a network accessible storage device.

Bus 116 may provide intercommunication among at least host system 102 and network component 118 as well as other peripheral devices (not depicted). Bus 116 may support serial or parallel communications. Bus 116 may support node-to-node or node-to-multi-node communications. Bus 116 may at least be compatible with Peripheral Component Interconnect (PCI) described for example at Peripheral Component Interconnect (PCI) Local Bus Specification, Revision 3.0, Feb. 2, 2004 available from the PCI Special Interest Group, Portland, Oreg., U.S.A. (as well as revisions thereof); PCI Express described in The PCI Express Base Specification of the PCI Special Interest Group, Revision 1.0a (as well as revisions thereof); PCI-x described in the PCI-X Specification Rev. 1.1, Mar. 28, 2005, available from the aforesaid PCI Special Interest Group, Portland, Oreg., U.S.A. (as well as revisions thereof); and/or Universal Serial Bus (USB) (and related standards) as well as other interconnection standards.

Network component 118 may be capable of providing intercommunication between host system 102 and network 120 in compliance at least with any applicable protocols. Network component 118 may intercommunicate with host system 102 using bus 116. In one embodiment, network component 118 may be integrated into chipset 105. “Network component” may include any combination of digital and/or analog hardware and/or software on an I/O (input/output) subsystem that may process one or more network protocol unit to be transmitted and/or received over a network. In one embodiment, the I/O subsystem may include, for example, a network component card (NIC), and network component may include, for example, a MAC (media access control) layer of the Data Link Layer as defined in the Open System Interconnection (OSI) model for networking protocols. The OSI model is defined by the International Organization for Standardization (ISO) located at 1 rue de Varembé, Case postale 56 CH-1211 Geneva 20, Switzerland. As used herein, a “network protocol unit” may include any packet or frame or other format of information with a header and payload portions formed in accordance with any protocol specification.

In some embodiments, a network component includes the capability to issue interrupts in response to receipt of network protocol units designated as regular and high priority or in response to other causes. A high priority interrupt may be requested for high priority network protocol units whereas a regular priority interrupt may be requested for regular priority network protocol units. A credit based mechanism controls the actual issuing of interrupts. An interrupt may be issued if a credit is available. In some embodiments, credits are incremented periodically and consumed when an interrupt is issued. Credits may be accumulated. In some embodiments, it is also possible to limit the rate of interrupts to some predetermined rate independent of the availability of credits.

Network 120 may be any network such as the Internet, an intranet, a local area network (LAN), storage area network (SAN), a wide area network (WAN), or wireless network. Network 120 may exchange traffic with network component 118 using the Ethernet standard (described in IEEE 802.3 and related standards) or any communications standard. The network component may be communicatively coupled to network 120 using a physical medium such as but not limited to a cable or any signal propagating medium.

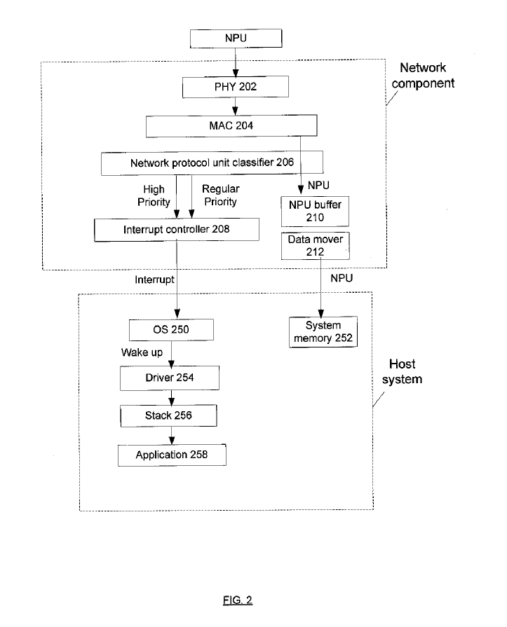

FIG. 2 depicts an example of elements that can be used to moderate interrupt message generation in accordance with some embodiments of the present invention. For example, network component may include physical layer interface (PHY) 202, media access controller (MAC) 204, network protocol unit (NPU) classifier 206, interrupt controller 208, NPU buffer 210, and data mover 212.

PHY 202 may be capable to receive network protocol units from and transmit network protocol units to a physical medium. For example, PHY 202 may receive and transmit network protocol units in conformance with applicable protocols such as Ethernet as described in IEEE Standard 802.3 (2002) and revisions thereof, although other protocols may be used.

MAC 204 may be used to perform media access control operations as prescribed by applicable protocols such as Ethernet, although other protocols may be used, as well as other protocol-related processing.

NPU classifier 206 may classify a priority of each received network protocol unit at least as regular or high priority. Network protocol units may be considered regular priority unless categorized as a high priority. High priority network protocol units may be selected based on any factors. For example, for network protocol units may be designated as high priority if a relevant protocol specifies a time limit by which the network protocol unit is to be received. For example, “ACK” and “PSH” Transmission Control Protocol (TCP) packets may be considered high priority network protocol units. Certain source or destination ports associated with network protocol units may be considered high priority. For example, network protocol units used to request data to be sent or used to coordinate parallel threads on different processing units may be considered as high priority. Small payload sized network protocol units may be considered high priority.

In some embodiments, NPU classifier 206 may use a configurable lookup table in order to define which network protocol units are designated high priority. NPU classifier 206 may issue an indication of whether a received network protocol unit is regular or high priority.

Interrupt controller 208 may receive requests to issue interrupts from a variety of sources. For example, to request an interrupt, network protocol unit classifier 206 may provide a priority level of a received network protocol unit. For example, an indication of a network protocol unit transmission may trigger a request to issue a regular priority interrupt. Other or alternative sources of requests for interrupts may be used.

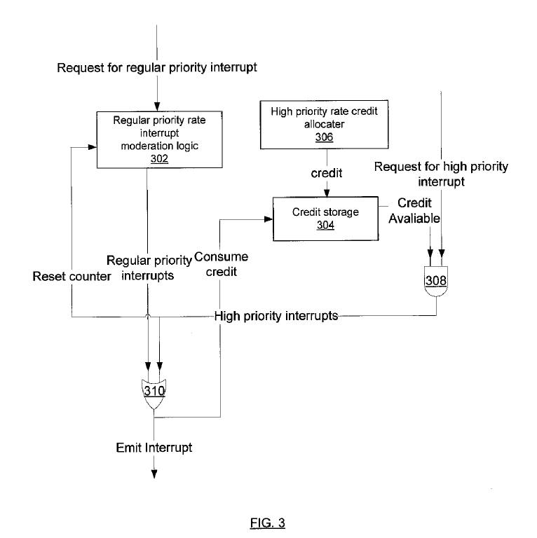

For example, interrupt controller 208 may transfer interrupts using an interrupt moderation scheme described with respect to FIG. 3, although other interrupt schemes may be used. In some embodiments, every Y microseconds, where Y>0, interrupt controller 208 may make available a regular priority to transfer even though the rate of requests for regular priority interrupts is higher. In some embodiments, interrupt controller 208 may transfer high priority interrupts based on a credit based scheme. For example, the credit based scheme may permit transfer of any high priority interrupt in response to a request for a high priority interrupt, provided a credit is available. A number of credits may be incremented every X microseconds, where X>0 and X<Y. Credits may be accumulated so that more than one is available at any time. The number of credits may be decremented by one each time a regular or high priority interrupt is transferred. A high priority interrupt may be released immediately provided one or more credit is available. Otherwise, a high priority interrupt may be released approximately every X microseconds.

In some embodiments, an interrupt may convey a vector number. A vector number may be associated with a cause of the interrupt. For example, a vector number may indicate receipt of a network protocol unit and the network protocol unit is stored at a specific queue number. For example, a vector number may be associated with transmission of a network protocol unit from a specific queue number. The interrupt that indicates a network protocol unit transmission may be considered regular priority.

Interrupts may be transferred to the host system in any manner. For example, the interrupt may be transferred in-band as a PCI-express message. For example, the interrupt may be transferred out-of-band via interrupt lines in PCI.

NPU buffer 210 may be capable to store one or more portion of network protocol units received from a network and that which at least MAC 204 and network protocol unit classifier 206 have processed. For example, header and payload portions of network protocol units may be stored. In some embodiments, NPU buffer 210 may store portions of network protocol units available for transmission to a network.

Data mover 212 may be capable to transfer a portion of a network protocol unit to system memory 252. For example, a descriptor issued to data mover 212 may instruct data mover 212 to transfer one or more portion of a network protocol unit to the host system.

System memory 252 may store one or more network protocol unit received from a network in one or more queue. An interrupt provided to the host system may reference a queue in system memory 252 that stores one or more network protocol unit received from a network. An interrupt provided to the host system may reference a queue in system memory 252 from which one or more network protocol unit was transmitted to a network. A queue may include addressable areas in a system memory capable of storing portions of network protocol units. In some embodiments, contents of a single queue are processed by at least one CPU. In some embodiments, contents of multiple queues are processed by a single CPU.

For example, host system may include operating system (OS) 250, system memory 252, device driver 254, stack 256, and applications 258. OS 250 may be any operating system executable by a processor. For example, suitable embodiments of OS 250 include, but are not limited to, Linux, UNIX, FreeBSD, or Microsoft Windows compatible operating systems. For example, OS 250 may support receive side scaling (RSS). OS 250 may receive one or more interrupt from interrupt controller 208. An interrupt may indicate that one or more network protocol units received from a network is present in a queue. An interrupt may indicate that one or more network protocol units have been transmitted from a queue. Operating system 250 may notify device driver 254 of the availability and location of such stored NPU by issuing a notice to “wake up”.

In some embodiments, an “MSI-X” feature defined in the PCT specification allows an interrupt message to provide a vector number. A network component may request MSI-X vectors and receive some allocation of these by an operating system. Device driver 254 can then allocate different queues to each vector. When a network protocol unit is received in a given queue, an interrupt is sent (after moderation) with the vector number associated to the queue. When a host system includes multiple CPUs, different vectors may be dedicated to different CPUs. Queues can be used to provide load balancing of network protocol unit processing between the CPUs.

Device driver 254 may be a device driver for a network component. Device driver 254 may process notifications from OS 250 that inform the host system of the storage of one or more network protocol unit into a queue in system memory 252. Device driver 254 may read a descriptor ring to determine which network protocol units are available. In response to detection of an interrupt that indicates a receipt of one or more network protocol unit, device driver 254 may check for network protocol units newly stored in a queue associated with the interrupt. For example, device driver 254 may keep track of the location of the queues it assigned to the network component and where it expects the network protocol units to be stored. Device driver 254 may call stack 256 to process available network protocol units. In response to receipts of interrupts, device driver 254 may call stack 256 to inform stack 256 of messages associated with the interrupts.

Stack 256 may process network protocol units stored in system memory 252 to determine protocol compliance. For example, stack 256 may determine whether network protocol units comply with TCP/IP standards. The TCP/IP protocol is described in the publication entitled “Transmission Control Protocol: DARPA Internet Program Protocol Specification,” prepared for the Defense Advanced Projects Research Agency (RFC 793, published September 1981). If the relevant portions of the network protocol unit comply with TCP/IP, at least the payload portion of the network protocol unit may be made available for use by applications 258. Stack 256 may determine compliance with protocols such as but not limited to User Datagram Protocol (UDP), Internet Control Message Protocol (ICMP), and Address Resolution Protocol (ARP).

Applications 258 can be one or more machine executable programs that access data from host system or network. Application 258 may include, for example, at least a web browser, an e-mail serving application, a file serving application, or a database application.

FIG. 3 depicts an example of elements that can be used to moderate interrupt message generation in accordance with some embodiments of the present invention. For example, the elements of FIG. 3 may be used by a network component to decide when to issue an interrupt to a host computer.

Regular priority rate interrupt moderation logic 302 may receive an indication that a network component received a network protocol unit having a regular priority. In response to an indication requesting a regular priority interrupt, regular priority rate interrupt moderation logic 302 may issue regular priority interrupts to gate 310, provided that regular priority rate interrupt moderation logic 302 issues an interrupt at no more than one interrupt every Y microseconds. In some cases, requests for interrupts may wait for an available regular priority interrupt to be released.

In some embodiments, regular priority rate interrupt moderation logic 302 releases a regular priority interrupt after a counter has counted from Y to 0 microseconds. In some embodiments, when a high priority interrupt is emitted from gate 308, a counter in regular priority rate interrupt moderation logic 302 may be reset to value Y. Resetting the counter may maintain a minimal rate at which interrupts are emitted, no matter if the emitted interrupts are regular or high priority.

High priority rate credit allocater 306 may issue a credit to credit storage 304 every X microseconds. Credit storage 304 may store and issue credits of high priority interrupts from high priority rate credit allocater 306. For example, credit storage 304 may issue a credit more often than every X microseconds provided that credit storage 304 stores a credit and that a request for a high priority interrupt is present. After credit storage 304 runs out of credits, credit storage 304 is replenished at a rate of one credit every X microsecond. A number of credits stored by credit storage 304 may be reduced by one each time gate 310 transfers an interrupt, regardless of whether regular or high priority interrupt. In some embodiments, credit storage 304 has a maximum number of credits it can store to guarantee that the local average of interrupts is maintained even in cases where the interrupt rate in the past was low.

In some embodiments, credits may be associated with a unique queue. In some embodiments, credits may be associated with multiple queues. In some embodiments, a queue is allocated to a single CPU so that a single CPU can process the network protocol units stored in the queue. In some embodiments, a queue is allocated to multiple CPUs so that multiple CPUs can process network protocol units stored in the queue. Work balancing among individual CPUs or among groups of CPUs may then be achieved. Each group of CPUs may include one or more CPU.

In response to a request for a high priority interrupt, gate 308 may transfer a high priority interrupt to gate 310 provided that a credit is available from credit storage 304. If requests for high priority interrupts are received at gate 308 more often than once every X microsecond and credits are available, then gate 308 may transfer high priority interrupts to gate 310 more often than once every X microseconds. Gate 308 may be implemented as a logic AND gate.

Gate 310 may transfer either a regular priority interrupt from logic 302 or a high priority interrupt from gate 308. The interrupt transferred by gate 310 may be provided from credit storage 304. A number of credits stored by credit storage 304 may be reduced by one each time gate 310 transfers an interrupt regardless of whether the interrupt is regular or high priority.

For example, the local average rate of interrupt emission from gate 310 may be set in such a way that the CPU utilization is kept stable and does not peak as a result of spikes in amounts of emitted interrupts.

If gate 310 receives both a regular and high priority interrupt at the same time, any tie breaking scheme may be used to decide which interrupt is emitted first. For example, a toggle scheme may be used so that priority toggles between regular and high priority.

In some embodiments, the embodiment of FIG. 3 can be used to moderate interrupts associated with a specific queue. For example, regular priority and high priority interrupts associated with the same queue may be moderated. In some embodiments, a single implementation of the embodiment of FIG. 3 can be used to moderate interrupts associated with multiple queues. For example, regular and high priority interrupts associated with different queues may be moderated by a single implementation of the embodiment of FIG. 3.

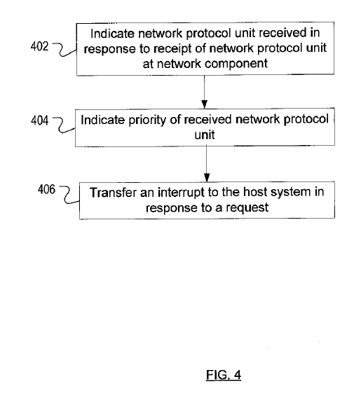

FIG. 4 depicts an example flow diagram that can be used to moderate transfer of interrupts to a host system in accordance with some embodiments of the present invention. In block 402, the process may indicate network protocol unit has been received in response to receipt of network protocol unit at a network component.

In block 404, the process may indicate a priority of a received network protocol unit. For example, priority may be one or regular or high priority. A priority of a network protocol unit may be indicated as regular unless identified as high priority. High priority network protocol units may be selected based on any factors. For example, for network protocol units may be designated as high priority if a relevant protocol specifies a time limit by which the network protocol unit is to be received. For example, “ACK” and “PSH” Transmission Control Protocol (TCP) packets may be considered high priority network protocol units. Certain source or destination ports associated with network protocol units may be considered high priority. For example, network protocol units used to request data to be sent may be considered as high priority. For example, network protocol units used to coordinate parallel threads on different processing units may be considered as high priority. Small payload sized network protocol units may be considered high priority.

In block 406, the process may transfer an interrupt to the host system in response to a request. For example, regular and high priority interrupts may be requested by indications of receipt of respective regular and high priority packets. In some embodiments, requests for interrupts may be provided from other sources such as but not limited to indications of transmission of one or more network protocol unit. In some embodiments, regular priority interrupts may be associated with indications of transmissions of one or more network protocol unit.

For example, high priority interrupts may be accumulated. A number of accumulated high priority interrupts may be decremented each time either a regular or high priority interrupt is transferred. Addition to a number of accumulated high priority interrupts may occur at a higher rate than a rate of availability of regular priority interrupts. A counter may be used to make regular priority interrupts available. The counter may be reset each time a high priority interrupt is provided.

Embodiments of the present invention may be implemented as any or a combination of: one or more microchips or integrated circuits interconnected using a motherboard, hardwired logic, software stored by a memory device and executed by a microprocessor, firmware, an application specific integrated circuit (ASIC), and/or a field programmable gate array (FPGA). The term “logic” may include, by way of example, software or hardware and/or combinations of software and hardware.

Embodiments of the present invention may be provided, for example, as a computer program product which may include one or more machine-readable media having stored thereon machine-executable instructions that, when executed by one or more machines such as a computer, network of computers, or other electronic devices, may result in the one or more machines carrying out operations in accordance with embodiments of the present invention. A machine-readable medium may include, but is not limited to, floppy diskettes, optical disks, CD-ROMs (Compact Disc-Read Only Memories), and magneto-optical disks, ROMs (Read Only Memories), RAMs (Random Access Memories), EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

Moreover, embodiments of the present invention may also be downloaded as a computer program product, wherein the program may be transferred from a remote computer (e.g., a server) to a requesting computer (e.g., a client) by way of one or more data signals embodied in and/or modulated by a carrier wave or other propagation medium via a communication link (e.g., a modem and/or network connection). Accordingly, as used herein, a machine-readable medium may, but is not required to, comprise such a carrier wave.

The drawings and the forgoing description gave examples of the present invention. Although depicted as a number of disparate functional items, those skilled in the art will appreciate that one or more of such elements may well be combined into single functional elements. Alternatively, certain elements may be split into multiple functional elements. Elements from one embodiment may be added to another embodiment. For example, orders of processes described herein may be changed and are not limited to the manner described herein. The scope of the present invention, however, is by no means limited by these specific examples. Numerous variations, whether explicitly given in the specification or not, such as differences in structure, dimension, and use of material, are possible. The scope of the invention is at least as broad as given by the following claims.

What is claimed is:

1. A method comprising:
providing a request for an interrupt in response to receipt of a network protocol unit, wherein the request includes a priority level of the network protocol unit; and
selectively transferring an interrupt in response to a request for an interrupt and in response to availability of an interrupt for transfer, wherein high priority interrupts are available more frequently than regular priority interrupts, wherein high priority interrupts are transferred whenever available, and wherein regular priority interrupts are available on a periodic basis.

2. The method of claim 1, wherein the selectively transferring comprises accumulating high priority interrupt credits at a rate of one every X microseconds, wherein X>0.

3. The method of claim 1, further comprising:
receiving an indication of a network protocol unit transmission; and
providing a request for a regular priority interrupt to indicate network protocol unit transmission.

4. The method of claim 1, wherein high priority interrupts are associated with network protocol units that include instructions to request data to be sent.

5. The method of claim 1, wherein high priority interrupts are associated with network protocol units that include instructions to coordinate parallel threads on different processing units.

6. The method of claim 1, further comprising:
making a regular priority interrupt available in response to counting from Y to 0; and
resetting the count to Y in response to transfer of a high priority interrupt.

7. The method of claim 1, wherein interrupts are associated with a single queue, wherein the single queue is capable to store at least one network protocol unit capable of being processed by at least one processor.

8. The method of claim 1, wherein interrupts are associated with multiple queues and wherein each queue is capable to store at least one network protocol unit capable of being processed by at least one processor.

9. An apparatus comprising:
logic to provide a regular priority interrupt in response to a request for a regular priority interrupt and availability of a regular priority interrupt; and
logic to provide a high priority interrupt in response to a request for a high priority interrupt and availability of a high priority interrupt credit, wherein credits are stored at a first rate, wherein availability of regular priority interrupts occurs at a second rate, and wherein the first rate is higher than the second rate.

10. The apparatus of claim 9, further comprising:
logic to classify a priority of a received network protocol unit, wherein the priority of the received network protocol unit is a regular priority unless indicated as high priority, wherein the logic to classify is to provide a request for a regular priority interrupt in response to a regular priority classification, and wherein the logic to classify is to provide a request for a high priority interrupt in response to a high priority classification.

11. The apparatus of claim 10, wherein the logic to classify comprises a look up table to indicate characteristics of received network protocol units associated with high priority interrupts.

12. The apparatus of claim 10, further comprising:
logic to provide an indication of a network protocol unit transmission; and
logic to request a regular priority interrupt for the indication of a network protocol unit transmission.

13. The apparatus of claim 9, further comprising:
logic to establish the second rate by counting from Y to 0; and
logic to reset the count to Y in response to transfer of a high priority interrupt.

14. The apparatus of claim 9, wherein interrupts are associated with a single queue, wherein the single queue is capable to store at least one network protocol unit capable of being processed by at least one processor.

15. The apparatus of claim 9, wherein interrupts are associated with multiple queues and wherein each queue is capable to store at least one network protocol unit capable of being processed by at least one processor.

16. A system comprising:
a communications medium;
a network component capable to receive and transmit network protocol units using the communications medium, wherein the network component comprises:
logic to classify a priority of a received network protocol unit, wherein the priority of the received network protocol unit is a regular priority unless indicated as high priority, wherein the logic to classify is to provide a request for a regular priority interrupt in response to a regular priority classification, and wherein the logic to classify is to provide a request for a high priority interrupt in response to a high priority classification;
logic to provide a regular priority interrupt in response to a request for a regular priority interrupt and availability of a regular priority interrupt, and
logic to provide a high priority interrupt in response to a request for a high priority interrupt and availability of a high priority interrupt credit, wherein credits are stored at a first rate, wherein availability of a regular priority interrupt occurs at a second rate, and wherein the first rate is higher than the second rate; and
a host system communicatively coupled to the network component and capable to receive interrupts from the network component.

17. The system of claim 16, further comprising:
logic to provide an indication of a network protocol unit transmission; and
logic to request a regular priority interrupt for the indication of a network protocol unit transmission.

18. The system of claim 16, further comprising:
logic to establish the second rate by counting from Y to 0; and
logic to reset the count to Y in response to transfer of a high priority interrupt.
